(19) United States
(12) Patent Application Publication
(10) Pub. No.: US 2008/0307931 A1
(43) Pub. Date: Dec. 18, 2008

(54) RATCHET WHEEL OF A WRENCH

(76) Inventor: CHIN-SHUN CHENG, Taichung (TW)

Correspondence Address: Chin-Shun Cheng, No.37-2, Ching-Dau 1st Street, Taichung, 404, TW

(21) Appl. No.: 11/761,369

(22) Filed: Jun. 12, 2007

(51) Int. Cl. B25B 23/00

(52) U.S. Cl. 81/60

(57) ABSTRACT

The present invention relates to a structure of wrench, which is mainly that a handle extends out from one side of a ratchet wheel integrally, a plurality of forefront surfaces and grooves are disposed around the internal periphery of the opening of the ratchet wheel in an interlaced order, and the forefront surfaces each has a concavity disposed on the middle portion of the protruded curved surface thereof. The concavities have different shapes from grooves and both are to be used to accommodate a workpiece. Besides, projected stop parts are provided on inside of the opening, with which the objectives of being suitable for various workpieces in multiple specifications and preventing the workpieces from passing through the ratchet wheel randomly would be achieved.

### FIELD OF THE INVENTION

This invention relates to a ratchet wheel of a wrench, and more particularly to a ratchet wheel that is suitable of being used for various workpieces in multiple specifications, and able to prevent the workpieces from passing through thereof randomly.

### BACKGROUND OF THE INVENTION

A conventional ratchet wheel 70 shown in FIG. 45 has an outer periphery provided with a plurality of engaging teeth 72 and an inner periphery with twelve V-shaped grooves 71, which can only fit a hexagonal or dodecagonal workpiece. Further, a conventional structure of wrench, such as U.S. Pat. No. 5,983,758, as shown in FIG. 46, has a handle 81 extending out integrally from one side of an annular driving head 80 that is internally equipped with twelve equidistant and continuous V-shaped grooves 82 with the same shape, six of the twelve equidistant V-shaped grooves 82 have each a stop part 83 on one end such that the six grooves 82 are not through. When the driving head 80 is engaged with a workpiece, top of a workpiece would be limited by the stop part 83 and then efficacy of preventing the workpiece taking off randomly from the wrench would be achieved. However, the conventional wrench aforementioned has the shortcoming as follows.

General workpieces have various shapes, such as gear-shaped, E-shaped, triangle, quadrangle, hexagon, etc. The conventional ratchet wheel 70 and driving head 80 aforementioned has twelve V-shaped grooves 72, 82, which can only fit a hexagonal or dodecagonal workpiece. Therefore, the conventional ratchet wheel 70 and driving head 80 is suitable for limited various workpieces so as to cause a shortcoming of inconvenience in use.

### SUMMARY OF THE INVENTION

The main objective of the present invention is to provide a ratchet wheel of a wrench that is suitable of being used for various workpieces, and for preventing the workpieces from passing through the ratchet wheel of the wrench randomly. The structure of the ratchet wheel is that a plurality of forefront surfaces and grooves are disposed around the internal periphery of the opening of the ratchet wheel in an interlaced order, and the forefront surfaces each has a concavity disposed on the middle portion of the protruded curved surface thereof. The concavities have different shapes from grooves and both are to be used to accommodate a workpiece together. Besides, projected stop parts are provided on inside of the opening, with which the objectives of being suitable for various workpieces in multiple specifications and preventing workpieces from passing through the wrench randomly would be achieved.

The present invention will become more obvious from the following description when taken in connection with the accompanying drawings that show, for purposes of illustration only, a preferred embodiment in accordance with the present invention.

### BRIEF DESCRIPTION OF THE DRAWINGS

FIG. 1 is a perspective view of the wrench of the present invention;

FIG. 2 is a top view of the wrench of the present invention;

FIG. 3 is a partial enlarged view of the wrench of the present invention;

FIG. 4 is a perspective view of rotating a hexagonal workpiece of the present invention;

FIG. 5 is a top view of rotating a hexagonal workpiece of the present invention;

FIG. 6 is a partial enlarged view of rotating a hexagonal workpiece of the present invention;

FIG. 7 is a perspective view of rotating a hexagonal workpiece of the present invention;

FIG. 8 is a top view of rotating a hexagonal workpiece of the present invention;

FIG. 9 is a partial enlarged view of rotating a hexagonal workpiece of the present invention;

FIG. 10 is a perspective view of rotating an E-shaped workpiece of the present invention;

FIG. 11 is a top view of rotating an E-shaped workpiece of the present invention;

FIG. 12 is a perspective view of rotating a gear-shaped workpiece of the present invention;

FIG. 13 is a top view of rotating a gear-shaped workpiece of the present invention;

FIG. 14 is a perspective view of the 2nd embodiment of the present invention;

FIG. 15 is a top view of the 2nd embodiment of the present invention;

FIG. 16 is a perspective view of the 3rd embodiment of the present invention;

FIG. 17 is a top view of the 3rd embodiment of the present invention;

FIG. 18 is a perspective view of the 4th embodiment of the present invention;

FIG. 19 is a top view of the 4th embodiment of the present invention;

FIG. 20 is a perspective view of the 5th embodiment of the present invention;

FIG. 21 is a top view of the 5th embodiment of the present invention;

FIG. 22 is a perspective view of the 6th embodiment of the present invention;

FIG. 23 is a top view of the 6th embodiment of the present invention;

FIG. 24 is a perspective view of the 7th embodiment of the present invention;

FIG. 25 is a top view of the 7th embodiment of the present invention;

FIG. 26 is a perspective view of the 8th embodiment of the present invention;

FIG. 27 is a top view of the 8th embodiment of the present invention;

FIG. 28 is a perspective view of the 9th embodiment of the present invention;

FIG. 29 is a top view of the 9th embodiment of the present invention;

FIG. 30 is a perspective view of the 10th embodiment of the present invention;

FIG. 31 is a top view of the 10th embodiment of the present invention;

FIG. 32 is a perspective view of the 11th embodiment of the present invention;

FIG. 33 is a top view of the 11th embodiment of the present invention;

FIG. 34 is a perspective view of the 12th embodiment of the present invention;

FIG. 35 is a top view of the 12th embodiment of the present invention;

FIG. 36 is a perspective view of the 13th embodiment of the present invention;

FIG. 37 is a top view of the 13th embodiment of the present invention;

FIG. 38 is a perspective view of the 14th embodiment of the present invention;

FIG. 39 is a top view of the 14th embodiment of the present invention;

FIG. 40 is a partial enlarged view of the 14th embodiment of the present invention;

FIG. 41 is a perspective view of the 15th embodiment of the present invention;

FIG. 42 is a top view of the 15th embodiment of the present invention;

FIG. 43 is a perspective view of the 16th embodiment of the present invention;

FIG. 44 is a top view of the 16th embodiment of the present invention; and

FIG. 45 is a perspective view of a ratchet wheel of the prior art; and

FIG. 46 is a perspective view of a wrench of the prior art.

### DETAILED DESCRIPTION OF THE PREFERRED EMBODIMENT

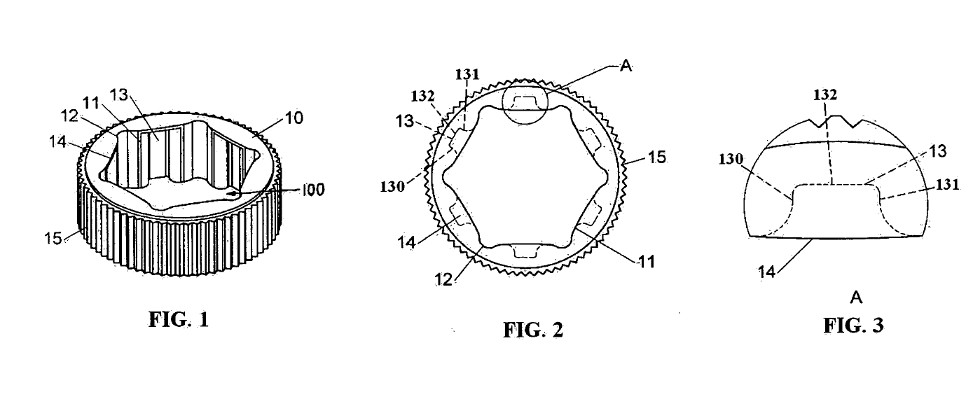

As shown in FIGS. 1 to 3, a basic structure of a ratchet wheel of a wrench of the present invention comprises a ratchet wheel 10. The ratchet wheel 10 is annular and has an outer periphery provided with plurality engaging teeth 15, and has a first end and a second end in opposite directions, and a central longitudinal axis that extends to connect the first end and the second end. At least one said end of the ratchet wheel 10 is equipped with an opening 100 extending along the central longitudinal axis. The opening 100 has a plurality of grooves 12 that are distributed equidistantly around the internal periphery thereof. The extending directions of the grooves 12 are parallel to the central longitudinal axis. A portion connecting each two adjacent said grooves 12 forms a forefront surface 11. Each forefront surface 11 is equipped with a concavity 13 on the middle thereof. The extending directions of the concavities 13 are parallel to the central longitudinal axis. The concavities 13 and the grooves 12 are able to accommodate the teeth of a gear-shaped workpiece together. Wherein, one said end of the ratchet wheel 10 is equipped with at least a stop part 14 projecting toward the central longitudinal axis on the inner of the opening 100, so that when the workpiece is inserted into the opening 100 from the other said end of the ratchet wheel 10, which can be blocked by the stop part 14.

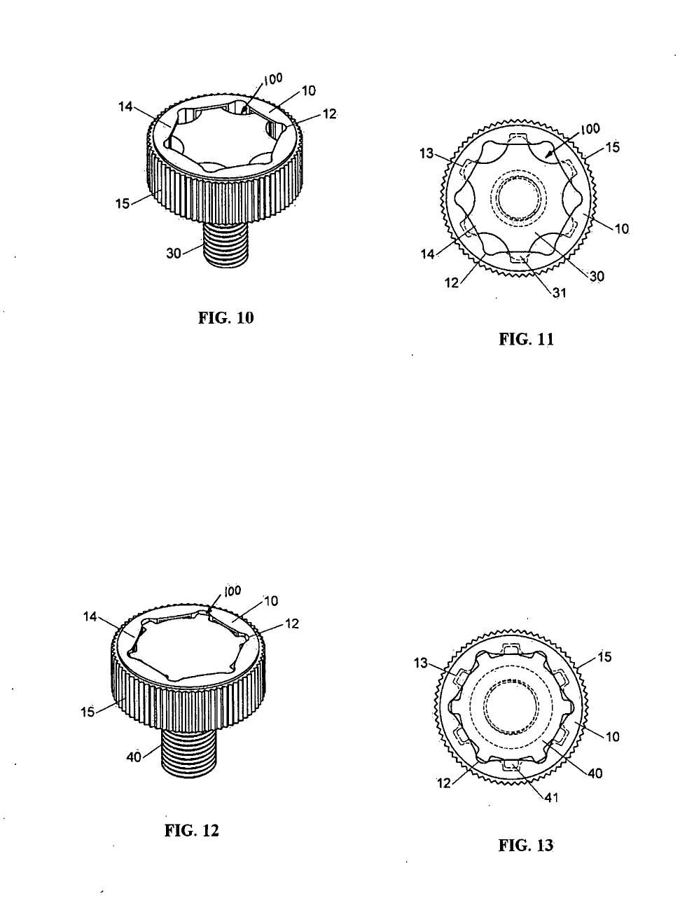

As shown in FIGS. 1 to 3, the number of the forefront surfaces 11 and the grooves 12 each are six, which are disposed annularly in an interlaced order. The forefront surfaces 11 may be a curved surface projecting toward the central longitudinal axis. The grooves 12 and the forefront surfaces 11 each are in the form of curved surfaces, and the junction of the two curved surfaces is tangent to each other. The number of the concavity 13 is six and the size of the concavity 13 is big enough to accommodate a tooth 41 of a gear-shaped workpiece 40 (as shown in FIGS. 12 and 13), or a tooth 31 of an E-shaped workpiece 30 with six encircling teeth (as shown in FIGS. 10 and 11). Moreover, in the embodiment of FIGS. 1 to 3, the concavity 13 includes two side surfaces 130, 131 and a bottom 132, in which the bottom 132 may be an arc surface or a flat surface. The included angle of the two side surfaces 130, 131 may be zero degree (namely parallel), greater or smaller than 90 degree. In the embodiment shown in FIGS. 1 to 3, the two side surfaces 130, 131 of the concavity 13 are parallel to each other, and the bottom 132 is a flat surface. Moreover, in the embodiment shown in FIGS. 1 to 3, the number of the stop part 14 is six and the stop parts 14 may be located on the concavities 13 near the first end of the ratchet wheel 10, which makes the concavities 13 not through. The distal end of the stop part 14 is in the form of a curved surface that is on the same curved surface as the forefront surface 11, with which the ratchet wheel 10 is able to fit on various shapes of workpieces and has the function of preventing the workpieces taking off randomly.

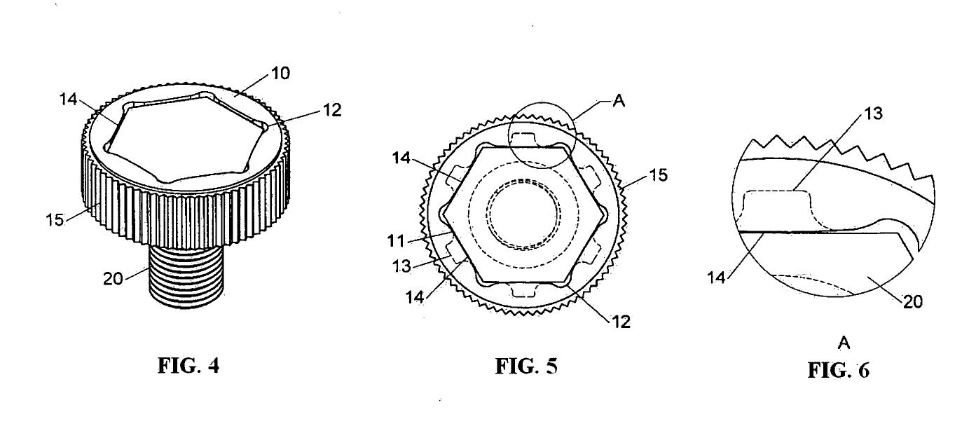

Referring to FIGS. 4 to 6, when the ratchet wheel 10 of the present invention accommodates a workpiece 20 with an angle, the forefront surfaces 11 of the ratchet wheel 10 are engaged with the six edges of the workpiece 20, which is the same as the conventional operation.

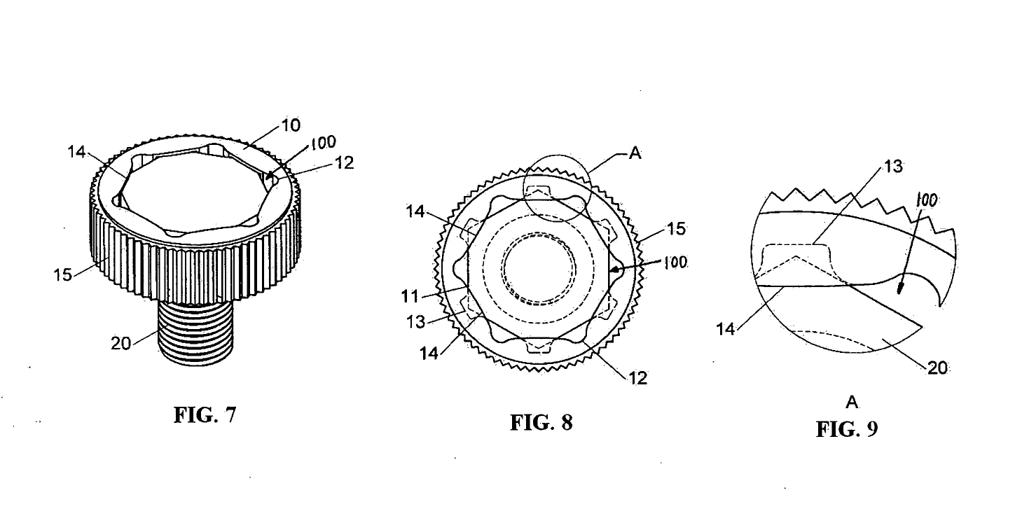

Referring to FIGS. 7 to 9, when the ratchet wheel 10 accommodates the workpiece 20 with another angle, the forefront surfaces 11 of the ratchet wheel 10 are also engaged with the six edges of the workpiece 20 and the top portions of the workpiece 20 touch the stop parts 14, so as to prevent the workpiece 20 from passing through the opening 100 of the ratchet wheel 10.

As shown in FIGS. 10 and 11, when the ratchet wheel 10 accommodates an E-shaped workpiece 30 with six teeth 31, the teeth 31 are accommodated within the concavities 13 and the top portions of the teeth 31 touch the stop parts 14, thus to prevent the E-shaped workpiece 30 from passing through the opening 100 of the ratchet wheel 10. In the embodiment of these two figures, the stop parts 14 are located on the concavities 13 near the first end of the ratchet wheel 10.

As shown in FIGS. 12 and 13, when the ratchet wheel 10 accommodates a gear-shaped workpiece 40 with twelve teeth 41, the teeth 41 are accommodated within the concavities 13 and the top portions of the teeth 41 touch the stop parts 14, thus to prevent the gear-shaped workpiece 40 from passing through the opening 100 of the ratchet wheel 10.

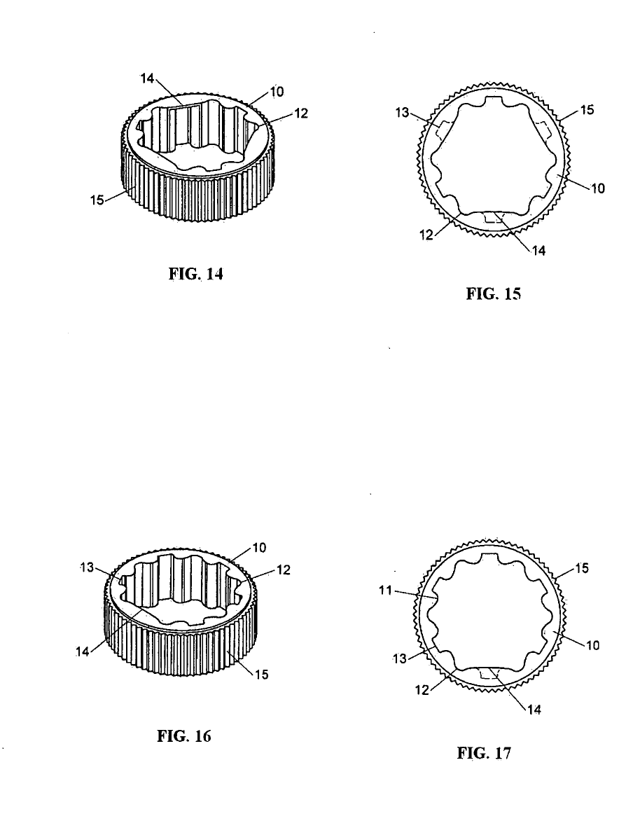

In the embodiment shown in FIGS. 14 and 15, the number of the stop part 14 is three, which are located on three equidistant said concavities 13 respectively.

In the embodiment shown in FIGS. 16 and 17, the number of the stop part 14 is one, which is located on one said concavity 13.

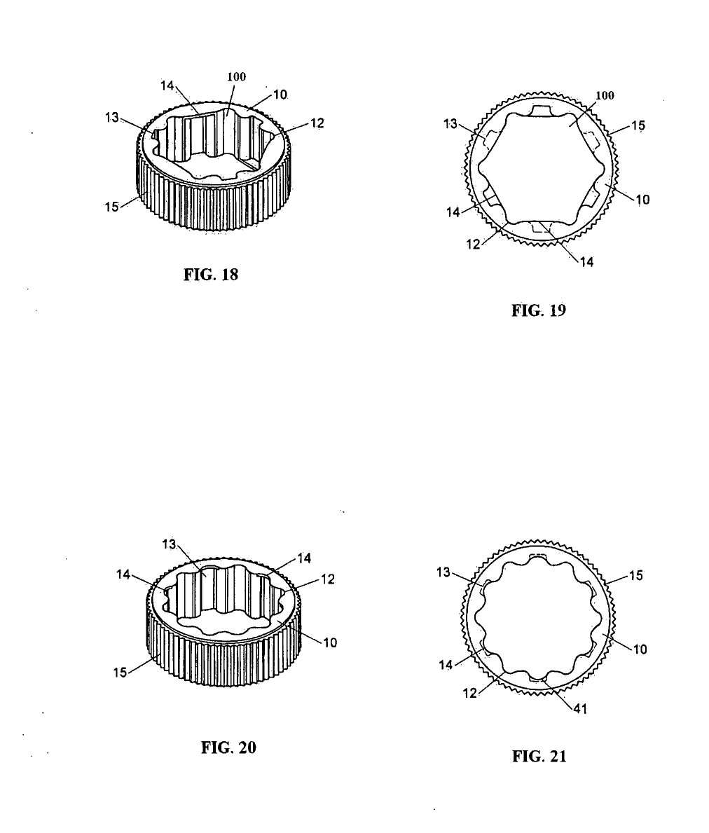

In the embodiment shown in FIGS. 18 and 19, the number of the stop part 14 is six, three of the stop parts 14 are located on the opening 100 near the first end of the ratchet wheel 10 and other three are located on the opening 100 near the second end of the ratchet wheel 10. The preferred embodiment of FIGS. 18 and 19 shows that three of the stop parts 14 are located equidistantly on the concavities 13 near the first end of the ratchet wheel 10 and other three are located equidistantly on the concavities 13 near the second end of the ratchet wheel 10.

In the embodiment shown in FIGS. 20 and 21, the distal ends of the stop parts 14 are formed as concave curved surfaces, the forefront surfaces 11 are convex curved surface, the junctions of the curved surfaces of the stop parts 14 and the curved surfaces of the forefront surfaces 11 are round corners. Furthermore, the distal ends of the stop parts 14 are formed as concave curved surfaces, and the shapes of the concave curved surfaces of the stop parts 14 can be the same as the groove 12.

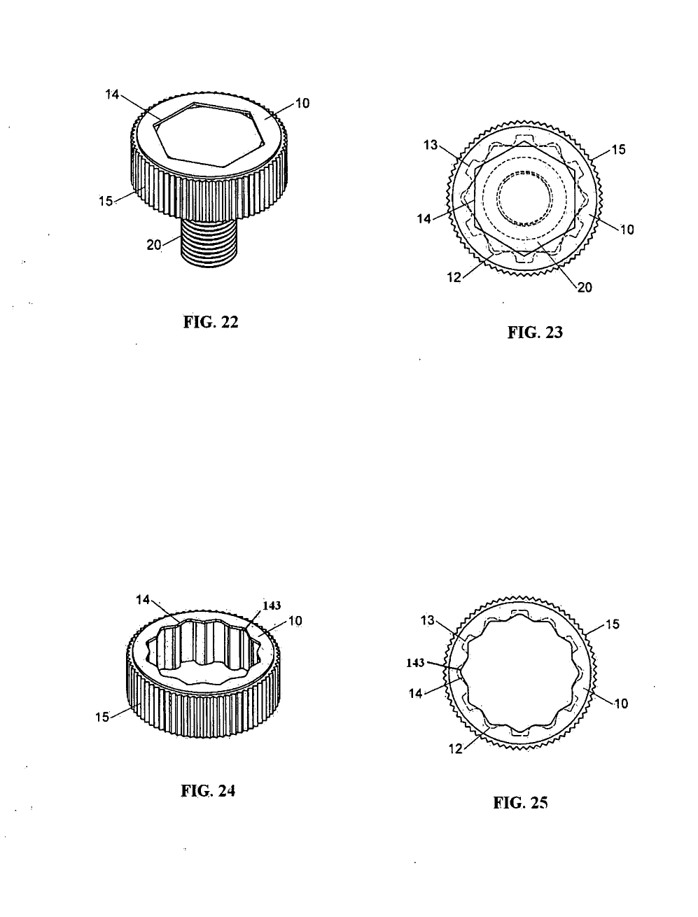

In the embodiment shown in FIGS. 22 and 23, the number of the stop part 14 is twelve, which are located on the grooves 12 and the concavities 13 one by one and are all located on the first end of the ratchet wheel 10. These stop parts 14 connect with each other to form a hexagonal inner circumference for accommodating another workpiece 20. If the forefront surfaces 11 of the ratchet wheel 10 can rotate a 19 mm workpiece, the inner circumference of the stop parts 14 can rotate an 18 mm workpiece.

In the embodiment shown in FIGS. 24 and 25, the number of the stop part 14 is twelve, which are located on the grooves 12 and the concavities 13 one by one and are all located on the first end of the ratchet wheel 10. The inner circumference formed by the connection of these stop parts 14 includes twelve round arc indentations 143 that have the same shapes and are spaced equidistantly.

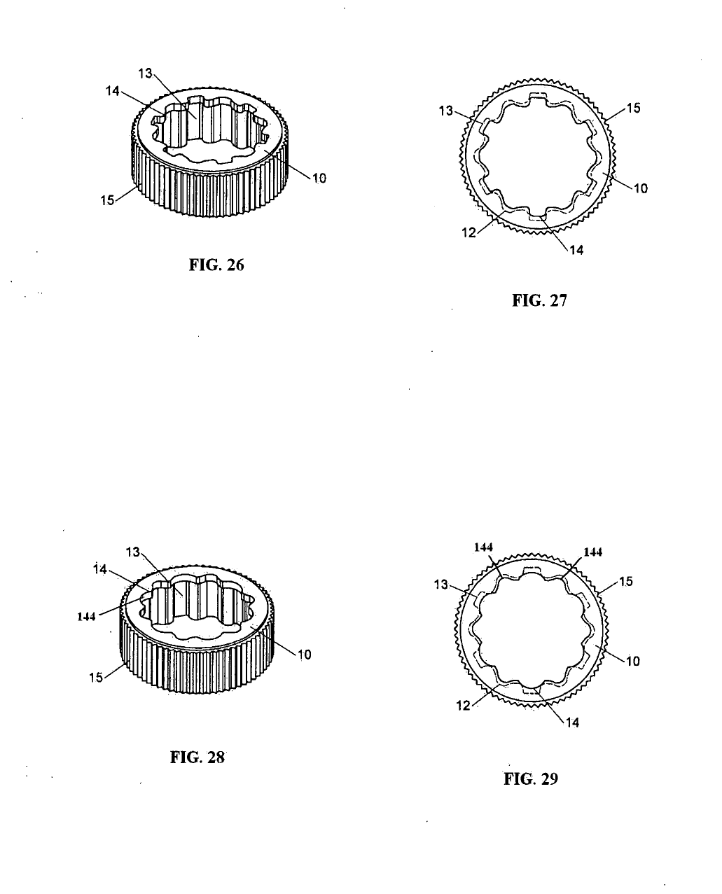

In the embodiment shown in FIGS. 26 and 27, the number of the forefront surface 11, the groove 12 and the concavity 13 each are six. The number of the stop part 14 is twelve, which are all located on the first end of the ratchet wheel 10. The shape of the inner circumference formed by the connection of these stop parts 14 is the same as the inner shape of the second end of the ratchet wheel 10.

In the embodiment shown in FIGS. 28 and 29, the number of the stop part 14 is twelve, which are all located on the first end of the ratchet wheel 10. The number of the forefront surface 11, the groove 12 and the concavity 13 each are six. The inner circumference formed by the connection of these stop parts 14 includes six equidistant first indentations 144. The shape of each said first indentations 144 is similar to the shape of the groove 12, which has the function of rotating dual size of workpieces.

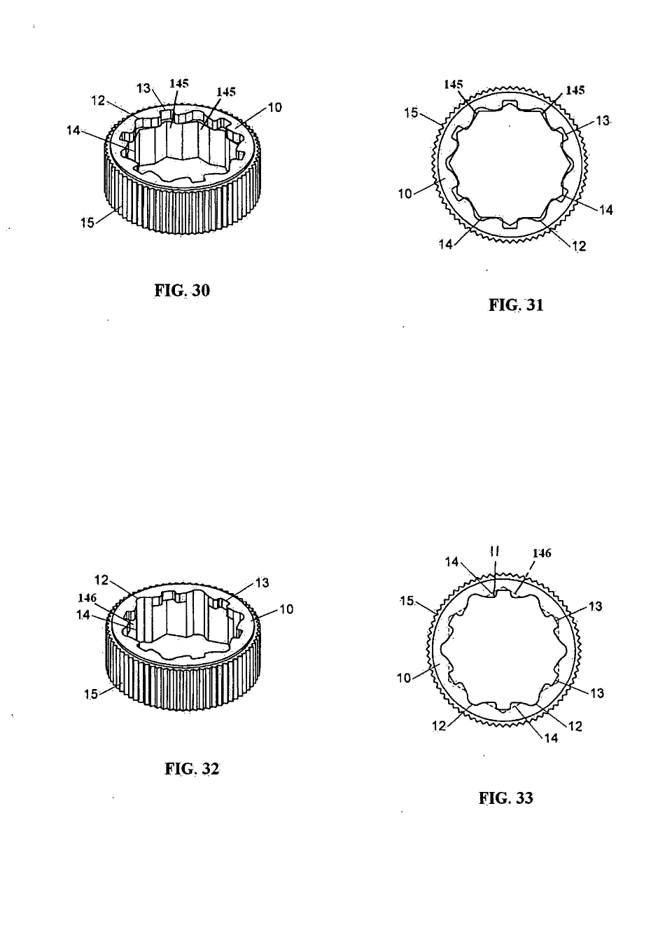

In the embodiment shown in FIGS. 30 and 31, the number of the stop part 14 is twelve, which are located on the grooves 12 and the concavities 13 one by one and are all located on the first end of the ratchet wheel 10. The inner circumference formed by the connection of these stop parts 14 includes twelve equidistant V-shaped second indentations 145.

In the embodiment shown in FIGS. 32 and 33, the number of the stop part 14 is twelve, which are located on the grooves 12 and the concavities 13 one by one and are all located on the first end of the ratchet wheel 10. The inner circumference formed by the connection of these stop parts 14 includes twelve equidistant V-shaped third indentations 146. The partial portions of the forefront surfaces 11 are more prominent than the third indentations 146.

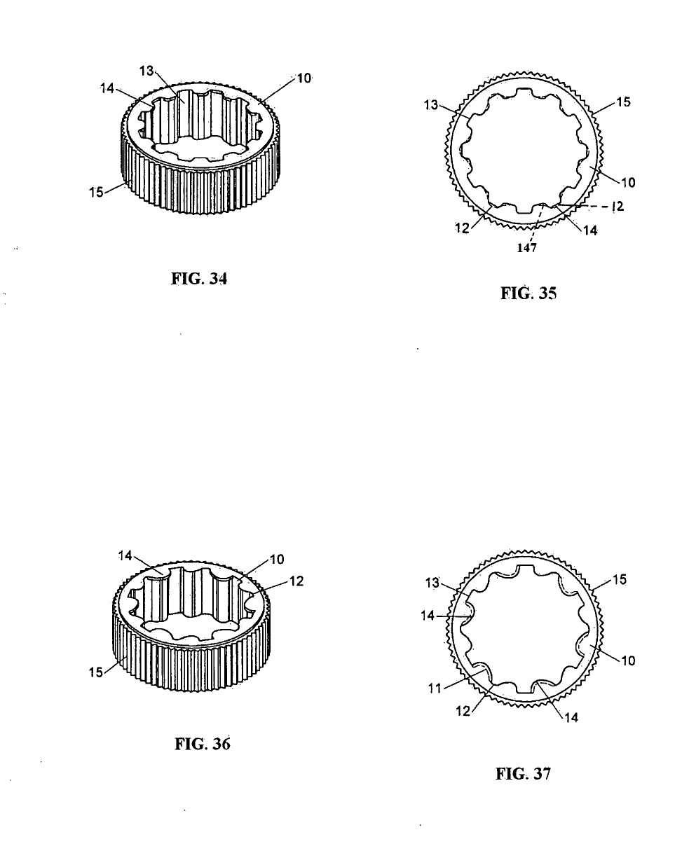

In the embodiment shown in FIGS. 34 and 35, the stop parts 14 are located on the grooves 12. In the embodiment shown in FIGS. 50 and 51, the ends of the stop parts 14 may have fourth indentations 147 that have the same shapes as the concavities 13.

In the embodiment shown in FIGS. 36 and 37, the stop parts 14 are located on the forefront surfaces 11.

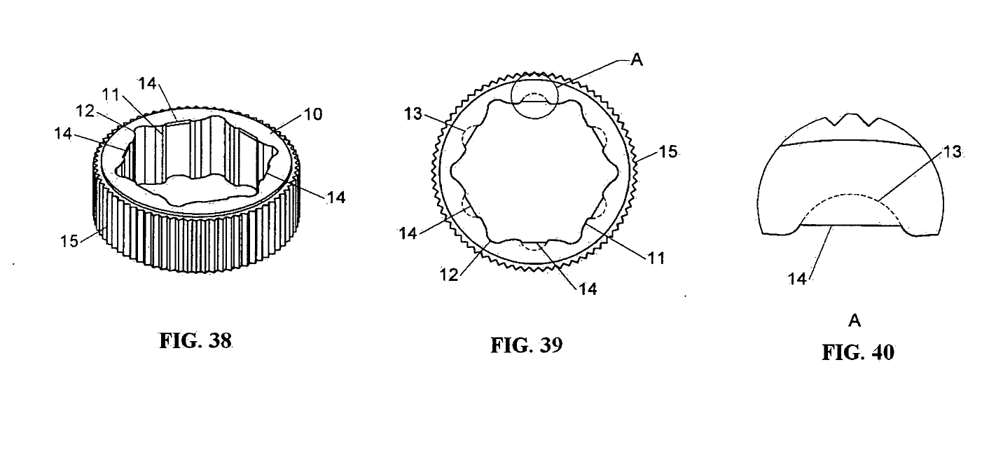

In the embodiment shown in FIGS. 38 to 40, the concavities 13 are round arc surfaces and the stop parts 14 are located on the concavities 13.

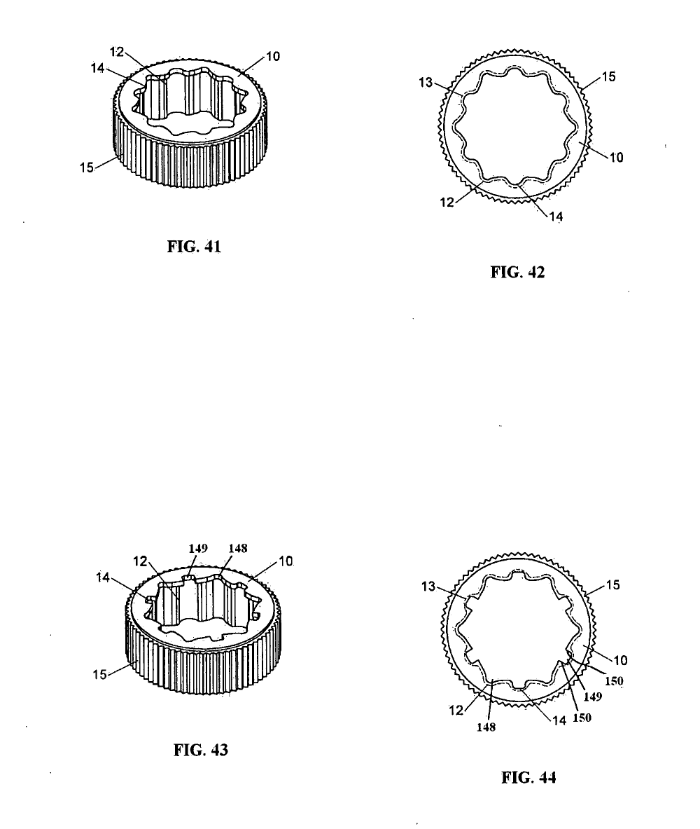

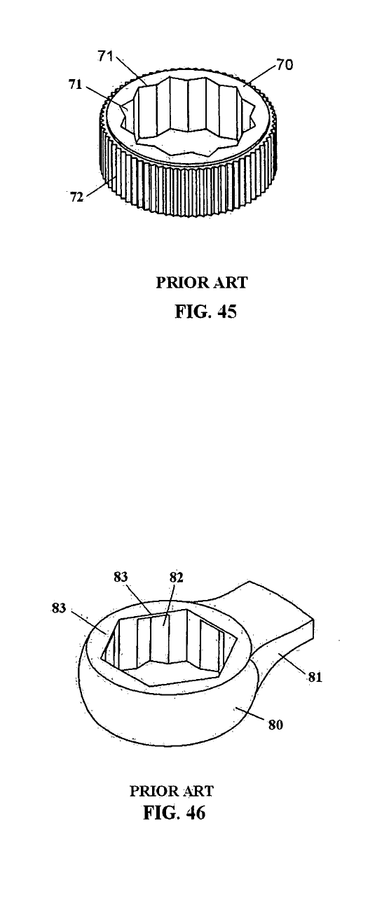

In the embodiment shown in FIGS. 41 and 42, the number of the forefront surface 11, the groove 12 and the concavity 13 each are six. Each said concavity 13 is a round arc surface. The number of the stop part 14 is twelve, which are all located on the first end of the ratchet wheel 10. The shape of the inner circumference formed by the connection of these stop parts 14 is similar to the inner shape of the opening 100 on the second end of the ratchet wheel 10.

In the embodiment shown in FIGS. 43 and 44, the number of the forefront surface 11, the groove 12 and the concavity 13 each are six, each said concavity 13 is a round arc surface. The number of the stop part 14 is twelve, which are all located on the first end of the ratchet wheel 10. The inner circumference formed by the connection of the stop parts 14 includes six equidistant fifth indentations 148 and six equidistant sixth indentations 149. The shape of each said fifth indentation 148 is similar to the shape of the groove 12, and each said sixth indentations 149 includes two parallel sides 150.

Another embodiment of the present invention, the forefront surface of the ratchet wheel includes at least two protruded curved surfaces, which is not shown with a figure.

While we have shown and described the embodiment in accordance with the present invention, it should be clear to those skilled in the art that further embodiments may be made without departing from the scope of the present invention.

1. A ratchet wheel of a wrench having an outer periphery provided with a plurality of engaging teeth has a first end and a second end in opposite directions, a central longitudinal axis extending to connect the first end and the second end, and an opening extending along the central longitudinal axis, the opening has a plurality of grooves distributed equidistantly around an internal periphery thereof, the extending directions of the grooves are parallel to the central longitudinal axis, a portion connecting each two adjacent grooves forming a forefront surface, wherein each forefront surface is equipped with a concavity on the middle thereof and the extending direction of the concavity is parallel to the central longitudinal axis, the shapes of the concavities and the grooves are different, the concavities and the grooves are able to accommodate teeth of a gear-shaped workpiece together, wherein one end of the ratchet wheel is equipped with at least a stop part projecting toward the central longitudinal axis on an inner of the opening, so that when the workpiece inserted into the opening from the other end of the ratchet wheel, which can be blocked by the stop part.

2. The ratchet wheel as claimed in claim 1, wherein the number of the forefront surface and the groove of the ratchet wheel each are six, which being disposed annularly in an interlaced order.

3. The ratchet wheel as claimed in claim 1, wherein the grooves and the forefront surfaces each are in the form of curved surfaces and a junction of the two curved surfaces is tangent to each other.

4. The ratchet wheel as claimed in claim 1, wherein the number of the concavity and the number of the forefront surface are the same.

5. The ratchet wheel as claimed in claim 1, wherein the number of the concavity is six and each of the concavities can accommodate a tooth of a workpiece with six equidistant encircling teeth.

6. The ratchet wheel as claimed in claim 1, wherein the concavity includes two side surfaces and a bottom.

7. The ratchet wheel as claimed in claim 6, wherein the two side surfaces of the concavity are parallel.

8. The ratchet wheel as claimed in claim 6, wherein an included angle of the two side surfaces of the concavity may be greater than 90 degree.

9. The ratchet wheel as claimed in claim 6, wherein an included angle of the two side surfaces of the concavity may be smaller than 90 degree.

10. The ratchet wheel as claimed in claim 6, wherein the bottom of the concavity may be an arc surface.

11. The ratchet wheel as claimed in claim 6, wherein the bottom of the concavity may be a flat surface.

12. The ratchet wheel as claimed in claim 1, wherein the number of the stop part is six.

13. The ratchet wheel as claimed in claim 1, wherein the stop part is located on the concavity near the first end of the ratchet wheel.

14. The ratchet wheel as claimed in claim 1, wherein a curved surface on a distal end of the stop part is on the same curved surface as the forefront surface.

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. The ratchet wheel as claimed in claim 1, wherein the forefront surfaces is a curved surface projecting toward the central longitudinal axis.

34. (canceled)

35. The ratchet wheel as claimed in claim 1, wherein the forefront surface comprises at least two protruded curved surfaces.

36. A ratchet wheel of a wrench having an outer periphery provided with a plurality of engaging teeth has a first end and a second end in opposite directions, a central longitudinal axis extending to connect the first end and the second end, and an opening extending along the central longitudinal axis, the opening has 6 grooves distributed equidistantly around an internal periphery thereof, the extending directions of the grooves are parallel to the central longitudinal axis, a portion connecting each two adjacent grooves forming a forefront surface so that the groove and the forefront surface are disposed annularly in an interlaced order, wherein each forefront surface is equipped with a concavity on the middle thereof and the extending direction of the concavity is parallel to the central longitudinal axis, the shapes of the concavities and the grooves are different, the concavities and the grooves are able to accommodate teeth of a gear-shaped workpiece together, wherein one end of each concavity near the first end of the ratchet wheel is equipped with a stop part projecting toward the central longitudinal axis, so that when the workpiece inserted into the opening from the other end of the ratchet wheel, which can be blocked by the stop part, and wherein the grooves and the forefront surfaces each are in the form of curved surfaces and a junction of the two curved surfaces is tangent to each other.

37. A ratchet wheel of a wrench having an outer periphery provided with a plurality of engaging teeth has a first end and a second end in opposite directions, a central longitudinal axis extending to connect the first end and the second end, and an opening extending along the central longitudinal axis, the opening has 6 grooves distributed equidistantly around an internal periphery thereof, the extending directions of the grooves are parallel to the central longitudinal axis, a portion connecting each two adjacent grooves forming a forefront surface so that the groove and the forefront surface are disposed annularly in an interlaced order, wherein each forefront surface is equipped with a concavity on the middle thereof and the extending direction of the concavity is parallel to the central longitudinal axis, the shapes of the concavities and the grooves are different, the concavities and the grooves are able to accommodate teeth of a gear-shaped workpiece together, each concavity can accommodate a tooth of a workpiece with six equidistant encircling teeth, and one end of each concavity near the first end of the ratchet wheel is equipped with a stop part projecting toward the central longitudinal axis, so that when the workpiece inserted into the opening from the other end of the ratchet wheel, which can be blocked by the stop part.
